(19) United States
(12) Patent Application Publication
(10) Pub. No.: US 2013/0291658 A1
(43) Pub. Date: Nov. 7, 2013

(54) DEVICE FOR CHARACTERIZING THE MECHANICAL PROPERTIES OF A MATERIAL WITH A LOW MODULUS OF ELASTICITY

(71) Applicants: Cyril Pailler-Mattei, Lyon (FR); Roberto Vargiolu, Millery (FR); Hassan Zahouani, Besancon (FR)

(72) Inventors: Cyril Pailler-Mattei, Lyon (FR); Roberto Vargiolu, Millery (FR); Hassan Zahouani, Besancon (FR)

(73) Assignees: ECOLE CENTRALE DE LYON, Ecully (FR); CENTRE NATIONAL DE LA RECHERCHE SCIENTIFIQUE, Paris (FR); UNIVERSITE CLAUDE BERNARD LYON I, Villeurbanne Cedex (FR); ECOLE NATIONALE D'INGENIEURS DE SAINT- ETIENNE, Saint Etienne (FR)

(21) Appl. No.: 13/884,626

(22) PCT Filed: Nov. 8, 2011
(86) PCT No.: PCT/FR2011/052592

§ 371 Date: Jul. 25, 2013

(30) Foreign Application Priority Data
Nov. 15, 2010 (FR) 1059388

(51) Int. Cl. G01L 1/04

(52) U.S. Cl. CPC G01L 1/04
USPC 73/862.621

(57) ABSTRACT

The present invention relates to a device for characterizing mechanical properties of a material (S) with a low modulus of elasticity, comprising an application surface (3) and a mechanical stressing mechanism (5), said mechanical stressing mechanism comprising: a mobile indenter (6) that can move at least in vertical translation so as to bear substantially normally on said material and on said application surface (3), at least one means (14) for translating said indenter along a vertical axis Z-Z′ from a reference position in which the indenter is not in contact with the material (S) and at least one sensor (11) for measuring the load applied by the indenter on the material (S) along a direction normal to the application surface on the material, and at least one position sensor (20) able to determine the vertical position of said indenter (6) with respect to said reference position.

### TECHNICAL FIELD

The present invention relates to the field of determining and characterizing mechanical properties of materials with a low modulus of elasticity.

The invention notably finds an application in the field of observing and diagnosing the condition of skin in humans or animals.

The invention more particularly applies to the field of diagnosing dermatological and aging pathologies of the skin by measuring mechanical properties of human or animal skin in vivo and in a non-invasive way.

### PRIOR ART

Presently, there are not very many tools, if any exist, for analyzing and/or diagnosing skin pathologies in vivo, whether this is for humans or animals. In a large majority of cases, the persons responsible for proceeding with such diagnoses only have their own eyes and theoretical knowledge for proceeding with the observation of skin tissue to be analyzed in the relevant patients and establishing a first diagnosis. The definitive diagnosis in a majority of cases then ensues from extensive analysis in laboratories (biopsies) of fragments of pathological skin tissues after sampling the latter on patients.

However, the “analytical” diagnosis consecutive to a sampling actually gives the possibility of determining a pathology and therefore the treatment applicable to the latter without however allowing fine analysis and understanding for medical personnel of the mechanical properties of the affected skin tissues nor even biophysical mechanisms involved at the tissues. This fine understanding of the properties of skin tissues represents a real challenge for the future in the field of dermatological research, in particular in order to allow a better understanding of the aging mechanisms of skin and therefore adapting medical control of these mechanisms.

There actually exist a few devices used in certain dermatology departments or cosmetic laboratories for qualitatively evaluating some characteristics of the mechanical behavior of skin. Nevertheless, these apparatuses are not very accurate, their results are difficult to interpret and they cannot be used on all the areas of the body.

It is also possible to further mention the devices described in patent applications WO 2008/156515 A2, WO 03/010515 A1, WO 2005/023093 A2 or further JP 2000 316818 A as an indication of devices for characterizing skin properties. However, these devices do not allow characterization of the anisotropic properties of skin, data which are however essential for understanding the mechanisms of aging or the effects of certain skin diseases.

### DESCRIPTION OF THE INVENTION

Also, a first object of the present invention is to provide an analysis device which allows a better understanding of the biophysical mechanisms set into play during the natural or pathological aging process of the skin.

Another object of the present invention is to provide an analysis device adapted for ambulatory diagnosis of skin pathologies, in a rapid and simple way, by any medical personnel, in hospital centers and dermatology practices notably.

Another object of the present invention is to provide an analysis device which allows objective and reliable determination of the mechanical properties of any material with a low modulus of elasticity, and notably of the skin. In particular, the invention aims at providing a simple and reliable solution allowing qualification of the mechanical properties of a material regardless of the mechanical stresses of said material and their orientations, and therefore qualification of the anisotropic properties of the material.

These different objects are achieved by means of a device for characterizing mechanical properties of a material with a low modulus of elasticity including an application surface on such a so called material. According to the invention, this device also includes a mechanism for mechanical stressing of the material with a low modulus of elasticity through the application surface, said mechanical stressing mechanism including an indenter at least moveable in vertical translation in order to provide a support on the material with low modulus of elasticity along a direction substantially normal to said material and to said application surface. The mechanical stressing mechanism also includes at least one means for translating said indenter along a vertical access Z-Z′ from a reference position in which the indenter is not in contact with the material with low modulus of elasticity, at least one sensor for measuring the force applied by the indenter on the material along a direction normal to the surface of application on the material, and at least one position sensor capable of determining the vertical position of said indenter relatively to said reference position. The device of the invention finally includes at least one element for causing oscillation of the indenter along a tangential direction to the application surface, the element for causing oscillation of the indenter being secured to a tangential force sensor.

The device proposed by the present invention has a simple and inexpensive structure, easy to be made in miniaturized form or at the very least with reduced size allowing its use in hospital centers and dermatology practices in ambulatory form. With the device of the invention, it is possible to carry out a study of the biophysical and physico-chemical behavior of a material with a low modulus of elasticity like the cutaneous membrane of a patient over all the areas of his/her body. Finally, with the possibility of miniaturization of the device, it is possible to specifically localize the skin areas of the patient having dysfunction or a pathology, which represents a key challenge in diagnostic aid.

The characterization device of the invention thus forms a precious tool in improving knowledge and understanding of the mechanical characteristics of the skin during aging and during certain pathologies such as melanoma, cutis laxa, Ehler-Danlos for example.

The characterization device of the invention in particular gives the possibility of characterizing the stiffness of a material such as a skin tissue depending on age or on a disease, but also, in a totally novel way, on the mechanical shearing properties of the material and therefore qualification and quantification, by combining the analysis of two stress movements of the indenter, the anisotropy of the material, such as for example of the skin of a patient, in its thickness.

It also allows tracking of the time-dependent change of the efficiency of skin treatments for the pathologies mentioned earlier.

The proposed device gives the possibility of correlating the mechanical behavior of the skin with certain of its pathologies. It also allows tracking of the time-dependent change in the mechanical behavior of the skin membrane depending on different applied treatments. As this observation is non-invasive, it is clearly less cause of trauma for patients than the conventional techniques for observing the effect of a treatment, which biopsies may be.

According to a first original characteristic of the device of the invention, the indenter includes an axis secured to the translational means and an indentation head.

In particular, according to the invention, the indentation head has a geometry selected from the following forms: sphere, dihedral, cone, cylinder or plane.

The selection of the geometry of the indentation head advantageously depends on the type of characterization of the skin of a patient which is desired to be obtained such as for example the use of a cone for improving the accuracy of the contact and applying a constant deformation, a dihedral for analyzing the anisotropic nature of the material, or further a sphere in order to have the average properties of the contact area.

According to a first alternative embodiment, the inventor is removable and interchangeable.

According to another alternative embodiment, it is only the indentation head which is removable and interchangeable.

Advantageously, the inventor is mounted on a mechanism for vertical translational guiding relatively to the surface of application of the device and the contact surface of the material.

According to a preferred characteristic of the device of the invention, the mechanism for guiding the indenter includes at least one plate or spacer for attaching the axis of the indenter along said vertical axis Z-Z′, said plate or spacer being secured through said translational means.

In this preferred embodiment, advantageously, said plate or spacer is further mounted slideably on guiding sliders parallel to the Z-Z′ axis.

Still advantageously, the guiding mechanism includes means for returning the indenter into said reference position. In particular, the return means in a preferred embodiment are coil springs.

Preferably, the means for translating the indenter is a micromotor.

Advantageously, the element causing oscillation of the indenter is a piezo-electric transducer.

Advantageously, the surface of application is formed by a planar face of a circular crown, the centre of which is located on the Z-Z′ axis for vertical translation of the indenter.

Still advantageously, the mechanism for stressing the device is rotationally mobile around the vertical axis Z-Z′ of the indenter.

In a preferred embodiment, the mechanical stressing mechanism is further advantageously accommodated in a stiff covering or shell secured to an upper surface of the crown opposite to the application surface.

Further, always in this preferred embodiment, said mechanical stressing mechanism includes a frame supporting the guiding mechanism of the indenter and the translational means, said frame resting on an upper surface of the crown.

In order to allow certain characterizations of the skin tissue, the characterization device of the invention may also in a particular embodiment be such that the application surface is coated with a contact adhesive.

Finally, in order to allow efficient use and continuous acquisition and analysis and/or a posteriori measurements carried out by means of the device of the invention, the latter also includes a device for controlling the translation means of the indenter and of the element causing oscillation of the indenter, a device for amplifying the signals transmitted by the force and position sensors and by the tangential force sensor, and a digital device for recording and analyzing said signals.

Various other characteristics will emerge from the description made below with reference to the appended drawings which show, as non-limiting examples, the embodiments of the object of the invention.

### DESCRIPTION OF THE FIGURES

In the appended figures:

FIG. 1 schematically illustrates the device for characterizing mechanical properties of a skin tissue in a preferred embodiment,

FIG. 2 illustrates a top view of the applicator of the device of the invention without any protective shell;

FIG. 3 illustrates a median sectional view along the axis Z-Z′ of the indenter of the applicator of the device of the invention in a preferred embodiment, the indenter being in a mechanical load position;

FIG. 4 illustrates a sagittal sectional view along the axis Z-Z′ of the indenter of the applicator of the device of the invention in a preferred embodiment, the indenter being in the rest position;

FIGS. 5 to 7 illustrate in a view similar to the one of FIG. 3, the operation of the device of the invention in a loading and unloading succession of the indenter;

FIG. 8 illustrates curves of resistance to penetration of the skin versus age, obtained by applying the device of the invention;

FIG. 9 illustrates stiffness curves of the skin versus age, obtained by applying the device of the invention;

FIGS. 10 and 11 illustrate skin adherence curves versus moisturization of the skin, obtained by applying the device to the invention;

FIG. 12 illustrates skin adherence curves obtained during tests on three subjects, one being affected with Cutis Laxa.

### DETAILED DESCRIPTION OF AN EMBODIMENT

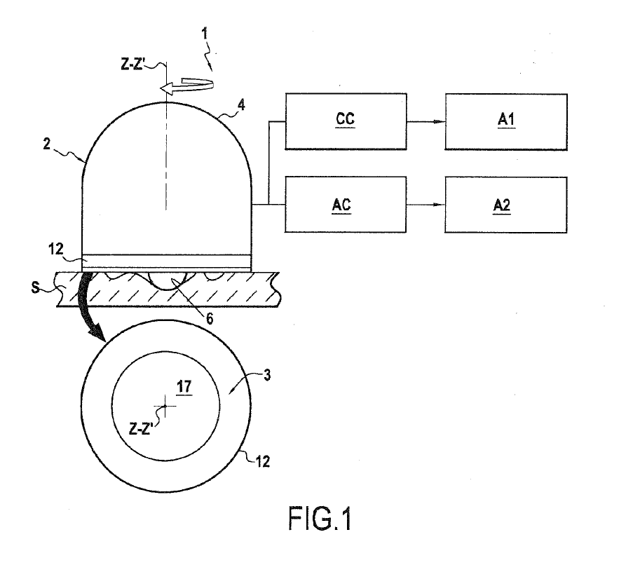

FIG. 1 schematically illustrates the device 1 for characterizing mechanical properties of a material with a low modulus of elasticity of the present invention. This characterization device 1 may be used on any material with a low modulus of elasticity in order to characterize the mechanical behavior of this material; however, the device 1 of the invention was most particularly developed with a purpose of characterizing mechanical properties of skin tissues and the description which follows is made with reference to such an application.

The characterization device 1 consists of an applicator 2 including a planar application surface 3 on a material with a low modulus of elasticity such as a skin tissue S to be analyzed and diagnosed and a shell or covering 4 for manual gripping in order to allow a medical practitioner to affix the application surface 3 of the applicator onto the skin tissue S. The applicator 2 also includes a mechanism for mechanically stressing 5 a skin tissue S, accommodated in the covering 4 and including an indenter 6 moveable in vertical translation along a vertical axis Z-Z′ relatively to the application surface 3 of the applicator in the direction of the skin tissue S from a rest or reference position, set back from the application surface 3 inside the covering 4.

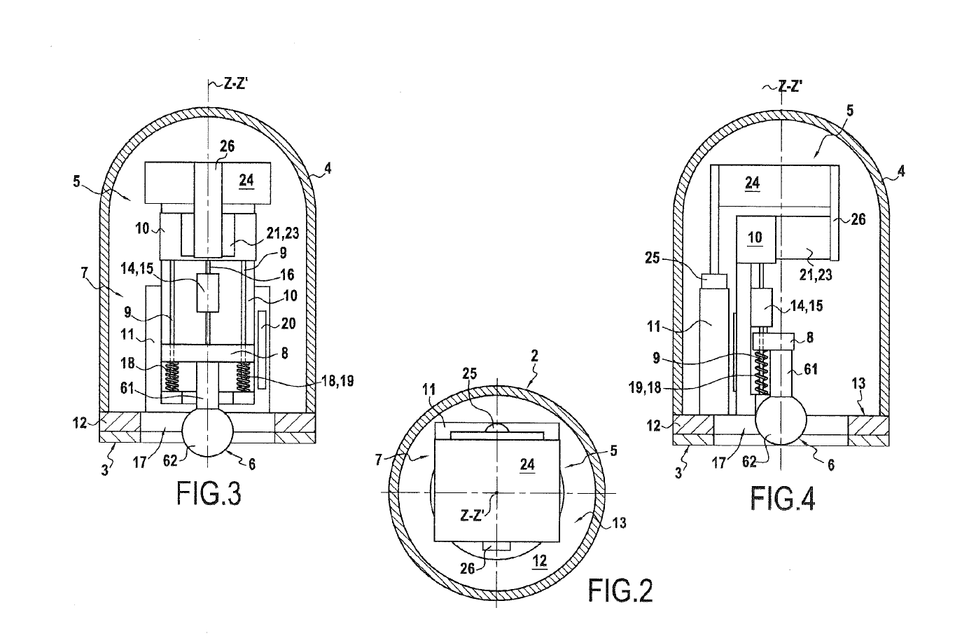

The mechanical stressing mechanism 5, illustrated in detail in FIGS. 2 to 6, first includes the indenter 6, consisting of an axis 61 directed along the vertical translation axis Z-Z′ of the indenter 6 and bearing at its lower end an indentation head 62. This indentation head 62 may be fixed or removable from the axis 61 and may have a variable geometry selected according to the properties of a skin tissue S which is desirably tested and diagnosed. In particular, the indentation head 62 may be selected with a spherical shape in order to measure the overall mechanical properties of a skin tissue S, with a dihedral shape in order to determine the anisotropic properties of the tested material, or further with a conical shape in order to determine the local properties of the tested material. The indentation head 62 may further be of cylindrical or planar shape if necessary.

In its upper end opposite to the indentation head 62, the axis 61 of the indenter is secured to a guiding mechanism 7 including a plate 8 slideably mounted on sliders 9 parallel to the axis Z-Z′ and mounted on a gantry 10 secured in extension to a normal force sensor 11 attached on an upper surface 13 of a circular crown 12, the lower surface of which defines the planar application surface 3 of the applicator.

The guiding mechanism 7 also includes a means 14 for translating the indenter 6, or more exactly the plate 8 bearing the indenter 6, in the preferred form of a micromotor 15 actuating a worm screw 16, a lower end of which is fitted into the plate 8. The micromotor 15 is advantageously driven by a computer control console CC incorporating a program for driving the device and analyzing the obtained measurement data. Thus, when the micromotor 15 is actuated, the latter meshes with the worm screw 16 which then moves along an axis parallel to the extension axis Z-Z′ of the indenter 6, which is found displaced in translation from its rest position along said axis Z-Z′ relatively to the skin tissue S through the circular aperture 17 made by the crown 12.

In order to facilitate the return of the indenter 6 to its rest position after penetration into the skin tissue 5, the guiding mechanism also includes return means 18 in the form of coil springs 19, for example, slipped onto the sliders between the base of the gantry and the plate 8. These springs allow return of the indenter to its reference position and control of its displacement during its downward movement to contact with a material to be characterized.

The normal force sensor 11 of the mechanical stressing means 5 is advantageously adhesively bonded onto a section of the upper surface 13 of the crown 12. It is intended to measure the force applied along the axis Z-Z′ by the indenter 6 on a skin tissue S during the penetration of the indenter 6 on this skin tissue S. For this, the force sensor 11 is connected to the control console CC of the device 1 as well as to a first signal amplifier A1. The measurement of the normal force Fn notably allows determination of the behavior of the material S onto which the device is applied under a determined force and displacement. The normal force sensor 11 is surmounted with the gantry 10 on which is attached the guiding mechanism 7. Said guiding mechanism 7 is thus maintained on the gantry 10 suspended above the circular aperture 17 delimited by the internal edge of the crown 12 so that the indenter 6 extends along its vertical translation axis Z-Z′ which passes through the centre of the crown 12 and of the circular aperture 17 which it makes.

The mechanical stressing mechanism of the device 1 of the invention also includes a position sensor 20 for measuring the position of the indenter 6 along the axis Z-Z′ relatively to a determined reference position, in particular a rest position of the indenter 6 as illustrated in FIG. 4, wherein the head 62 of the indenter 6 is located set back from the application surface 3 of the applicator 2 and from the skin tissue S when said application surface 3 is applied on said skin tissue S. This position sensor 20 thus notably allows determination of the penetration depth of the indenter 6 into the skin tissue S from the rest position during the use of the device 1 of the invention on a patient. The position sensor 20 is itself also connected to the control console CC of the device for recording the signals transmitted by the sensor 20.

The stressing mechanism 5 of the characterization device 1 of the invention preferably also finally includes at least one element 21 for causing oscillation of the indenter 6 along a tangential direction to the application surface 3 secured to a tangential force sensor 22. This element 21 for causing oscillation of the indenter 6 is connected to a control actuator AC which drives it and has the function of causing vibration of the indenter 6 according to a determined and adjustable frequency F between 10 and 50 Hz for example and with a low amplitude in order to determine the mechanical properties upon shearing the tested material S. In practice, the element 21 for causing oscillation of the indenter is formed by a piezo-electric transducer 23 attached on the gantry 10 of the guiding device 7 and also secured to a tangential force sensor 24 itself attached and suspended above the normal force sensor 11 by a mast 25 surmounting said normal force sensor 11. Moreover, the piezo-electric transducer 23 is as for it attached on. the tangential force sensor 24 by means of a junction strip 26 adhesively bonded between said transducer 23 and said tangential force sensor 24. The piezo-electric transducer 23 and the tangential force sensor 24 are both electrically connected to the control actuator AC and to a second signal amplifier A2 for the signal transmitted by the tangential force sensor 24.

The crown 12 forming the application face 3 of the applicator 2 may advantageously consist of Teflon® or further of any other material dermatologically inert towards the skin. Advantageously, this crown 12 is such that it allows rotation of the stressing mechanism 5 around the axis Z-Z′ when the application surface 3 of the crown 12 is in contact with the surface of the material to be characterized.

Practically, the application surface 3 will be coated, during the use of the characterization device 1 of the invention, with a contact adhesive on the surface of the material S to be characterized.

The covering 4 as for it may be made in any plastic material. It notably facilitates the handling of the applicator 2 by a practitioner for carrying out a measurement on the skin tissue S of a patient in order to characterize the mechanical properties of this skin tissue S and if possible establish a diagnosis on a declared pathology or the time-dependent change of a pathology diagnosed beforehand.

The device of the invention was designed in order to allow objective and repetitive characterization of the mechanical properties of a skin tissue S in vivo in order to notably allow diagnosis and tracking of skin pathologies. This device 1 operates simply by affixing the applicator 2 with its planar contact surface 3 onto a skin tissue S to be tested and/or displacing said applicator 2 on said skin tissue S by sliding the planar contact surface 3 over the skin tissue S.

An example of the use of the device 1 of the invention is thus reported hereafter, for example applied by a medical practitioner (physician, dermatologist for example) on a patient in a static position for the duration of the test.

The practitioner before beginning defines the normal force test Fn to be applied by the indenter 6 of the device 1 on the skin tissue area S of the patient to be tested. This normal force Fn may be adjusted on the control console CC of the device 1 between 40 and 100 mN.

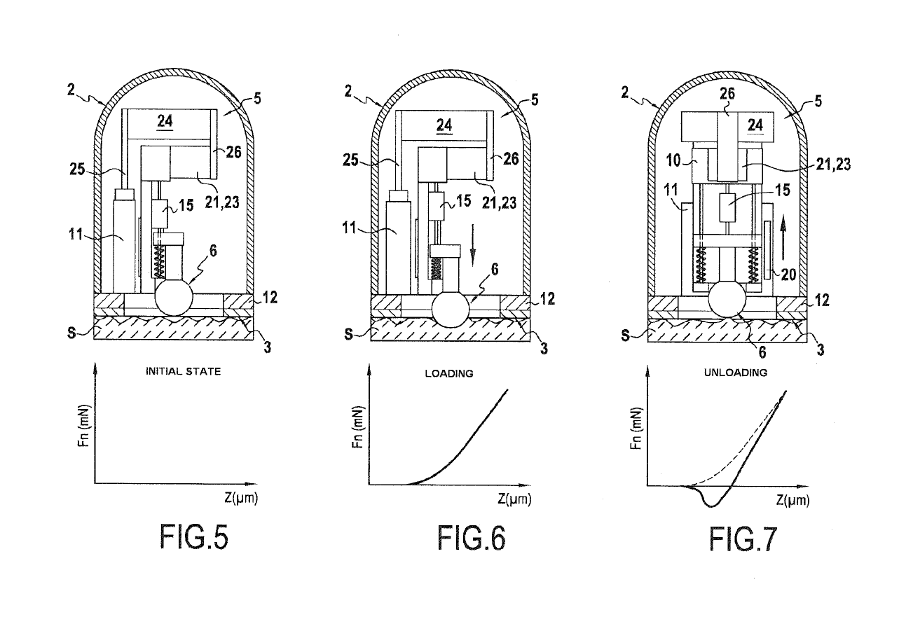

The practitioner then applies the contact surface 3 of the crown 12 of the applicator 2 of the device 1 on the skin tissue area S to be tested. The micromotor 15 then displaces the indenter 6 along the vertical axis Z-Z′ from its rest position (FIG. 5), the indenter 6 vertically penetrating into the skin tissue S (FIG. 6) until the force sensor 11 detects the pre-adjusted force value. The device 1 is then “in a loading condition”. The piezo-electric transducer 23 is then actuated at a pre-adjusted frequency F by the practitioner in order to cause oscillation of the indenter 6 at a low amplitude (a few micrometers) in order to measure the shearing forces Ft (shear modulus, viscosity) of the skin of the patient via the tangential force sensor 24.

Once the shearing measurements have been carried out, the micromotor 15 moves in the opposite direction (FIG. 7) until the indenter 6 again reaches its rest position. This second phase corresponds to the “unloading” of the device 1. The result obtained corresponds to the variation of the measured force Fn versus the penetration distance Z of the indenter 6 in the skin tissue S of the patient on the tested area. For the shearing measurements, the obtained result corresponds to the phase lag between the measured tangential force Ft and the displacement imposed by the indenter.

With accomplishment of the indentation test, it is possible to characterize the mechanical behavior of the skin tissue S in its volume, and also to measure the physico-chemical properties such as the adhesive nature of the surface of said skin tissue S. These different parameters may notably be obtained by modifying the geometry of the indentation head 62 of the indenter 6 of the device 1. The shearing test as for it gives the possibility of measuring the mechanical behavior of a material in the tangential direction to the skin tissue S and of obtaining its viscosity.

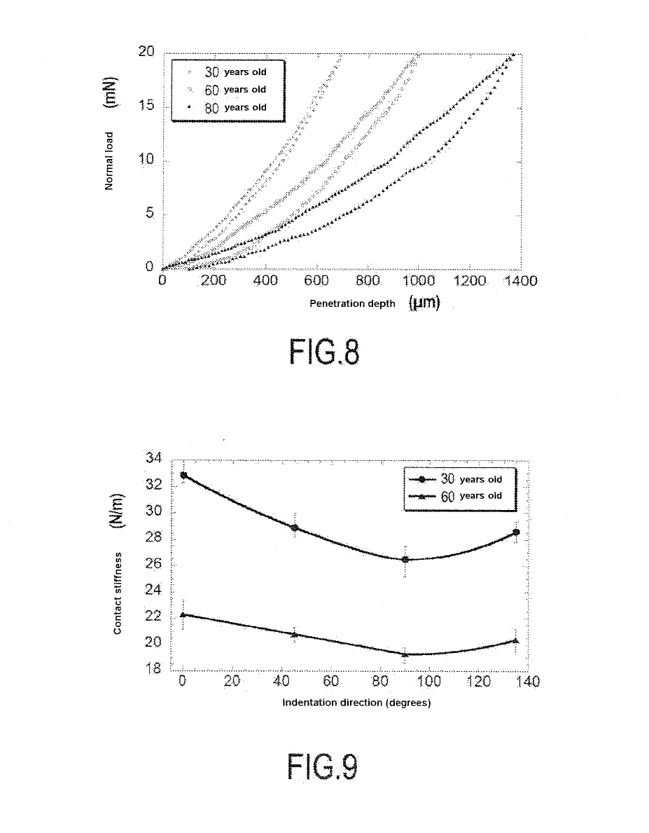

FIGS. 8 to 11 report examples of results obtained during tests conducted with the device 1 of the invention.

FIG. 8 illustrates various penetration curves of the indenter 6 in three skin tissues of various ages (30 years old, 60 years old and 80 years old) versus the normal force Fn applied on said skin tissue, after applying an indentation test as described earlier and illustrated in FIGS. 5 to 7. For each tested skin tissue, the loading and unloading curves obtained by means of the device 1 of the invention are illustrated in FIG. 8.

This test was carried out with a spherical indentation head 62 and allows characterization of the mechanical behavior of the skin versus aging. Thus, on the basis of the obtained curves, it may be seen that both the contact stiffness and the elasticity modulus of the skin decrease with aging, which is expressed on the curves by the slope differences (tangent lines at the origin) on the unloading section of the curves. Further, an increase in the hysteresis between the loading and unloading curves may also be seen on the attained curves, the older the tested skin tissue, which expresses an increase in the energy dissipation in the tissue, and therefore loss of tonicity of the latter.

FIG. 9 illustrates two contact stiffness curves of two skin tissues of 30 years and 60 years of age versus the indentation angle of the indenter 6 on said skin tissues, the indentation head 62 of the indenter 6 being of a dihedral shape. It may thus be seen that according to this test, the contact stiffness of a skin tissue strongly decreases, the older is said tissue. On the other hand, the mechanical response of the skin tissue to the mechanical stress of the indenter 6 depending on the stress direction is substantially similar regardless of the age of the relevant tissue. It may finally be also seen that the mechanical response of the tissue is variable depending on the stress direction. Therefore, there is mechanical anisotropy of the skin tissue, regardless of its age.

The thereby obtained results during the reported tests and illustrated by FIGS. 8 and 9 may find application in various cosmetic applications relating to moisturizing and tensioning issues of the skin as well as regards medical research on pathologies of the connective tissue of the skin and the follow-up of treatment of such diseases.

The characterization device 1 of the invention may also be used for conducting measurements of skin adherence and for observing for example capillarity forces between the skin and the indenter or further for measuring the maximum adhesion force to the surface of the skin.

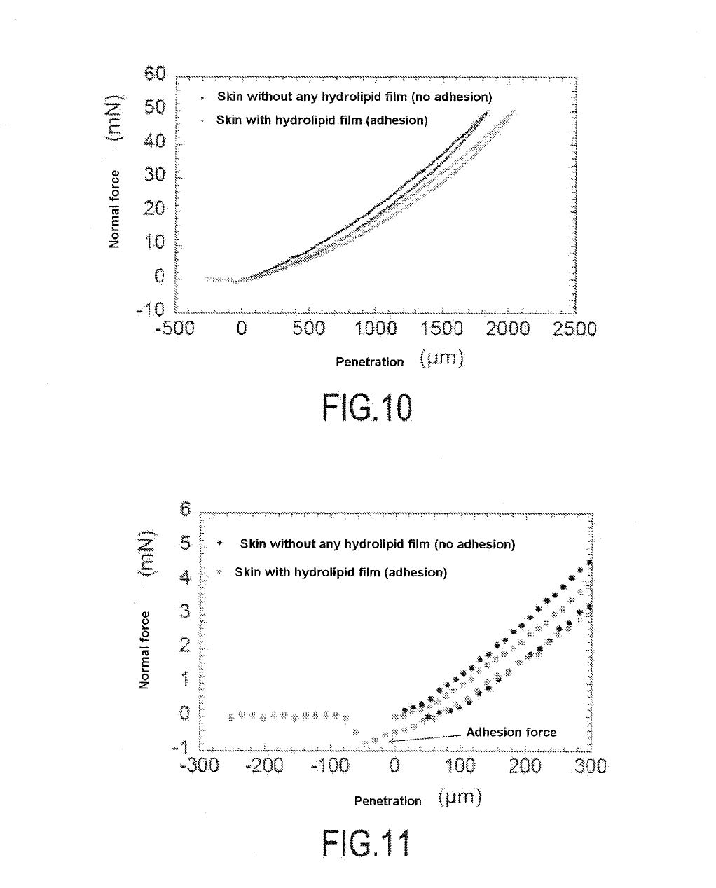

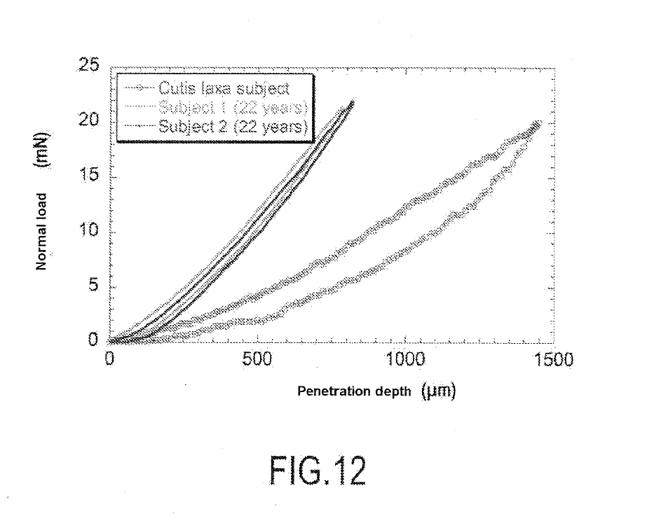

FIGS. 10 and 11 illustrate the curves obtained during tests similar to those reproduced in FIG. 8 but carried out this time on a dry skin tissue (skin) or covered with sebum.

From FIGS. 10 and 11, the conclusion may be drawn on the presence (sebum) or absence (without the sebum) of the adhesive nature of the skin of a subject.

Such findings may open onto cosmetic applications as well as medical applications, such as notably control of skin aging.

1. A device (1) for characterizing mechanical properties of a material (S) with a low modulus of elasticity, including an application surface (3) on a so-called material and a mechanism for mechanically stressing (5) the material through the application surface (3) said mechanical stressing mechanism including:
an indenter (6) moveable at least in vertical translation in order to provide a support on the material along a direction (Z-Z′) substantially normal to said material and to said application surface (3),
at least one translation means (14) of said indenter along a vertical axis Z-Z′ from a reference position in which the indenter is not in contact with the material (S) and
at least one sensor (11) for measuring the force applied by the indenter on the materials in (S) along a direction normal to the application surface on the material, and
at least one position sensor (20) capable of determining the vertical position of said indenter (6) relatively to said reference position,
at least one element (21) for causing oscillation of the indenter (6) along a tangential direction to the application surface (3), the element (21) for causing oscillation of the indenter being secured to a tangential force sensor (24).

2. The characterization device according to claim 1, characterized in that the indenter (6) includes an axis (61) secured to the vertical translation means (14) and an indentation head (62).

3. The characterization device according to claim 2, characterized in that the indentation head (62) has a geometry selected from the following forms: sphere, dihedral, cone, cylinder or plane.

4. The characterization device according to claim 2, characterized in that the indenter (6) is removable and interchangeable.

5. The characterization device according to claim 2, characterized in that the indentation head (62) is removable and interchangeable.

6. The characterization device according to claim 1, characterized in that the indenter (6) is mounted on a vertical translation guiding mechanism (7) relatively to the application surface (3) and to a contact surface of the material (S).

7. The characterization device according to claim 6, characterized in that the mechanism (7) for guiding the indenter includes at least one plate (8) or spacer for attaching the axis of the indenter (6) along said vertical axis Z-Z′, said plate or spacer being secured to said vertical translation means (14).

8. The characterization device according to claim 7, characterized in that said plate (8) or spacer is slideably mounted on guiding sliders (9) parallel to the axis Z-Z′.

9. The characterization device according to claim 6, characterized in that the guiding mechanism (7) includes means (18) for returning the indenter (6) to said reference position.

10. The characterization device according to claim 9, characterized in that the return means (18) are coil springs.

11. The characterization device according to claim 1, characterized in that the translation means (14) of the indenter is a micromotor (15).

12. The characterization device according to claim 1, characterized in that the element (21) for causing oscillation of the indenter is a piezo-electric transducer (23).

13. The characterization device according to claim 1, characterized in that the application surface (3) is formed by a planar face of a circular crown (12), the centre of which is located on the axis Z-Z′ of vertical translation of the indenter (6).

14. The characterization device according to claim 1, characterized in that the mechanical stressing mechanism (5) is rotationally mobile around the vertical axis Z-Z′ of the indenter.

15. The characterization device according to claim 13, characterized in that the mechanical stressing mechanism (5) is accommodated in a stiff covering (4) or shell secured to an upper surface (13) of the crown (12) opposite to the application surface.

16. The characterization device according to claim 13, characterized in that the mechanical stressing mechanism (5) includes a frame supporting the mechanism (7) for guiding the indenter (6) and the translation means (14), said frame resting on an upper surface (13) of the crown (12).

17. The characterization device according to claim 1, characterized in that the application surface (3) is coated with a contact adhesive.

18. The characterization device according to claim 1, characterized in that it also includes a control device (CC, AC) of the translation means of the indenter and of the element (21) for causing oscillation of the indenter, a device (A1, A2) for amplifying the signals transmitted by the force and position sensors and by the tangential force sensor (24) and a digital device for recording and analyzing said signals.
